(19) United States
(12) Patent Application Publication
(10) Pub. No.: US 2015/0272152 A1
(43) Pub. Date: Oct. 1, 2015

(54) PROCESS FOR THE PRODUCTION OF A LIPID PREPARATION WITH IMPROVED SPREADABILITY

(71) Applicant: DMK Deutsches Milchkontor GmbH, Zeven (DE)

(72) Inventors: Heinrich Hunfeld, Bassum (DE); Uwe Wärner, Elsdorf (DE)

(21) Appl. No.: 14/668,150

(22) Filed: Mar. 25, 2015

(30) Foreign Application Priority Data
Mar. 26, 2014 (EP) 14 161 735.7

(51) Int. Cl. A23C 15/02

(52) U.S. Cl. CPC A23C 15/02

(57) ABSTRACT

A process is proposed for the production of a lipid preparation with improved spreadability, in which mechanical mixing and kneading energy is put into the preparation and it is aerated with air or an inert gas at the same time.

### AREA OF THE INVENTION

The invention relates to the area of butter technology and concerns a process for the production of spreadable and long-life lipid preparations, in particular of butter.

### STATE OF THE ART

Butter is a pure and natural foodstuff which is used not only because of its good taste but also because of the nutrients it contains for the diet. Due to the fat-soluble vitamins A, D, E and beta-carotene it contains, butter is an important storage source of vitamins and in addition supplies minerals such as calcium. Furthermore, butter contains readily digestible butterfat. Butter is, however, solid at the temperature of a refrigerator. Therefore, it can only be processed with difficulty directly after removal from the refrigerator. This is not only annoying for the individual consumer but also in particular for industrial clients disadvantaged by having to put up with small packs that they have to work up again instead of with a large container from which they could fill directly.

Different processes are known from the state of the art for making butter spreadable even at low temperatures of about 7 to 10° C. Supplementation with additives that improve rheology such as milk, yoghurt, low-melting butter fractions or substantial amounts of vegetable fats such as rape oil is the normal method. Reference may be made, for example, to the publications DE 20 2006 011 600 U1, DE 20 2011 102 569 U1 or DE 20 2006 010 784 U1 (MEGGLE) in this connection. However, these additives generally lead to an adulteration of the taste and are therefore undesirable in many cases.

In the so-called Microfix process of the company Benhil the fat preparation is reworked in a homogeniser or kneading machine, preferably in a rotor-stator mixer. The crystal lattice is broken up by the input of mechanical energy, which results in a decrease in viscosity. However, a disadvantage is that this effect is not a lasting one. After some time agglomeration occurs again and the butter loses its spreadability again.

The task of the present invention therefore consisted in making available lipid preparations for foodstuffs in general and butter in particular that do not exhibit the disadvantages described at the beginning. In particular, it should not be necessary to admix substances in order to improve spreadability. A further focal point of the task therefore consisted in improving the spreadability of the preparations for a long period, thus excluding the observation that after a period of storage the spreadability has declined again.

### DESCRIPTION OF THE INVENTION

The object of the invention is a process for the production of a lipid preparation with improved spreadability, in which mechanical energy from mixing and kneading is put into the preparation and it is aerated with air or an inert gas at the same time.

It was found unexpectedly that in aerating the homogeniser small gas bubbles were incorporated into the defects of the crystal lattices, reliably preventing subsequent agglomeration and hence recrystallisation. The process is technologically simple and can be carried out in existing plants.

### Lipid Preparations

The process according to the invention can find application everywhere where there is a desire to improve the processability of lipid preparation at low temperatures for a long period. This concerns mainly—but not exclusively—lipid preparations for foodstuffs and in particular, of course, butter, including butter preparations such as herb butter as well as synthetic triglyceride mixtures with a comparable fatty acid spectrum.

The EU spreadable fat regulations and the German butter regulations define the term butter and its different types very accurately. It is accordingly a spreadable fat that remains firm and spreadable at 20° C., in the form of a solid elastic emulsion, predominantly of the W/O type, that consists exclusively of milk and/or certain dairy products with fat as an important component. Other substances required for production may be added, provided that these substances are not intended to replace a dairy component wholly or partly. Butter has a fat content of at least 80 wt. % and at most 90 wt. %, a maximum water content of 16 wt. % as well as a maximum content of fat-free dry milk solids of 2 wt. %. The high content of fat from saturated fatty acids (69 wt. % on average) is typical as well as the low content of polyunsaturated fatty acids (3 wt. % on average). The product name “butter preparation” is used for the combined range of products with a butterfat content of at least 62 wt. %.

On the other hand, blended fat spreads are products in the form of a solid plastic emulsion that were obtained from solid and/or liquid vegetable and/or animal products, and they have a butterfat content of 10 to 80 wt. % of total fat content.

In the present invention the term “lipid preparation” or equally “butter” is used collectively for all products that contain butter, regardless of their fat content and the proportion of butterfat.

The production of butter is based on the separation of cream from cow's milk. The main constituent of butter is therefore made up by butterfats, which are composed mainly of triglycerides and fatty acids. The fatty acids occurring in butter are, for example, butyric acid, caproic acid, caprylic acid, capric acid, lauric acid, myristic acid, myristoleic acid, pentadecanoic acid, palmitic acid, palmitoleic acid, margaric acid, stearic acid, oleic acid, elaidic acid, linoleic acid and linolenic acid. Butterfat has a relatively high content of short-chain saturated fatty acids and a relatively low content of polyunsaturated fatty acids (e.g., linoleic acid, linolenic acid).

The melting points of the butterfats contained in butter are in the range of about 4° C. to 50° C. depending on the fat molecule. On the basis of the different melting points, it is possible to separate butter physically by fractionation, i.e., to separate individual fractions with specific physical properties.

In the fractionation of butterfat, dehydrated butter is heated and then cooled again to the desired crystallisation temperature. The high-melting triglycerides crystallise out first, while the low-melting fraction remains liquid. In one two-stage fractionation used in the state of the art the “stearin” (clear melting point 41° C. to 48° C.) and “olein” fractions, for example, are separated at the first stage. The two fractions can be fractionated again in a second stage. A “hard stearin” with a melting point of 46° C. and a “soft stearin” with a melting point of 36° C. can be obtained from “stearin”. The “olein” can be separated into a “mid-fraction” with a melting point of 26° C. and “super olein” with a melting point of 12° C. or lower. In fractionation triglycerides from long-chain saturated fatty acids are enriched in the higher melting phase, while in the low-melting phase there are more short-chain and unsaturated fatty acids.

It is thus possible to vary the particular proportion of the different butterfats and thereby change the properties of a butter mix fat. In particular, the melting point of a butter mix fat can be controlled by variation of the composition of the butterfats. In the composition of the present invention fractionated butterfats support both the pliability at refrigerator temperatures and the shape stability at room temperature. These butter oils preferably have a melting temperature of about 8° C. to about 12° C.

### Additives

Beyond the extent to which the process according to the invention provides an improvement in the spreadability of the preparations, the latter can contain additives that produce a further rheological improvement.

In order to prepare a preparation that has the desired pliability at room temperature, it can contain a higher proportion of butter fractions with a low melting point than butter. The proportion of additional low-melting butter fractions can in principle be freely chosen so that the desired consistency of the butter is obtained. The selection of particular butter fractions and the proportion in which they are contained in the composition according to the invention is not restricted. The area of knowledge of the specialist, depending on the type of butter fractions used and the possible additional components contained in the composition, is to be used so that the desired consistency is obtained. In this way the low-melting butter fractions are contained at a level of about 2 wt. % to about 8 wt. % and preferably from 2.5 wt. % to about 3.5 wt. %. However, the addition is dependent on the taste properties of the butter as far as possible not being altered unfavourably, in particular that the “buttery” taste is not lost. This restricts the use of butter fractions for improving rheology, so that this measure for achieving better and lasting spreadability, as already explained at the beginning, is not sufficient on its own.

### Process

The process according to the invention can in principle be carried out in standard homogenisers or kneading machines.

For example, products such as the SHG model of the company FASA or the Benhil Microfix 8471 of the company Benhil can be considered. The machines are generally made of high-quality steel and offer a continuous output of up to 1500 kg/h. The homogenisers operate at temperatures in the region of about 5° C. to about 20° C. and in particular from about 8° C. to about 15° C. Homogenisation, i.e., the mechanical input of mixing or kneading energy takes place according to the rotor-stator principle with rotating blades and screws or a combination of both elements. Typically the homogenisers contain 12 to 16 impellers that are operated at speeds of about 500 rpm to about 900 rpm and preferably about 700 rpm to 800 rpm. The screws rotate, for example, at 12 to 22 rpm.

Aeration of the homogeniser can take place with any gases, while for reasons of cost it is suitable to use air. It is, however, possible to use oxygen or an inert gas such as nitrogen. It has thus proved particularly advantageous to conduct aeration under pressure, hence to use compressed gases, preferably compressed air. The latter can have a pressure of 1 bar to about 8 bar. In principle higher pressures are also possible, the use of which is however less favoured because special plants that are expensive to purchase are needed for this purpose, while the effect is approximately the same. The use of compressed gases is favoured, with compressed air at about 3 bar to 5 bar preferred.

The appropriate machines from the state of the art can be upgraded for aeration without any problems. It is in principle sufficient to fix gas frits on the base of the homogenisers so that the compressed air is forced through the homogenising mass from below. This must of course take place so that neither the rotary blades nor the screws are impeded or damaged in their operation by the frits.

### EXAMPLES

### Comparative Example C1

A conventional butter was homogenised for 15 minutes batchwise at an input temperature of 8° C. and a processing temperature of 15° C. in a homogeniser of the company Benhil (Microfix 8471 model). The spreadability was then evaluated on a scale of (1)=good spreadability to (4)=virtually solid at 15° C. immediately after removal from the homogeniser as well as after storage over 1 to 4 hours. Butter without homogenisation was also included as the control experiment.

### Examples 1 to 3

The comparative example Cl was repeated but gas was passed via a gas frit into the homogeniser at (a) 1 bar, (b) 3 bar and (c) 5 bar. The three types of butter treated in this way were subsequently evaluated as above. The results are summarised in Table 1.

### Table 1

Spreadability of Butter

| Spreadability | Control | C1 | 1 | 2 | 3 |
|---|---|---|---|---|---|
| Immediately | 4 | 2 | 2 | 1 | 1 |
| After 1 hour | 4 | 3 | 2 | 1 | 1 |
| After 2 hours | 4 | 4 | 3 | 2 | 1 |
| After 4 hours | 4 | 4 | 3 | 2 | 1 |

The examples and comparative examples clearly show that by aeration of the homogeniser, particularly by means of compressed air, recrystallisation of the butter is reliably prevented. Once it has been made spreadable, the butter no longer loses this property even on further storage.

1. A process for the production of a lipid preparation with improved spreadability and a lipid content of about 80 to about 90% b.w., in which mechanical mixing and kneading energy is put into a preparation and it is aerated with air or an inert gas at the same time,
whereby said aeration is conducted at
(i) a temperature within the range of about 8 to about 15° C., and
(ii) a gas pressure of about 1 to about 8 bar.

2. The process of claim 1, wherein said a preparation is butter or a synthetic triglyceride mixture with a comparable fatty acid spectrum.

3. The process of claim 1 wherein said a preparation contains furthermore about 2 wt. % to about 8 wt. % of a low-melting butter fraction.

4. The process of claim 1, wherein the aeration takes place in a homogeniser.

5. The process of claim 1, wherein the mechanical mixing or kneading energy is put into the preparation via a rotor-stator mixer.

6. The process of as claim 1, wherein the preparation is aerated with air, oxygen or an inert gas during the mechanical treatment.

7. The process of 1, wherein the aeration is carried out with a compressed gas.

8. (canceled)

9. The process of claim 1, wherein the aeration is carried out with compressed air at 3 to 5 bar.
